(19) United States
(12) Patent Application Publication
(10) Pub. No.: US 2010/0331129 A1
(43) Pub. Date: Dec. 30, 2010

(54) FRICTION DRIVE BELT

(75) Inventors: Fumihiro Mukai, Kobe-shi (JP); Tomoyuki Yamada, Kobe-shi (JP); Hiroyuki Tachibana, Kobe-shi (JP); Hiroyuki Shiriike, Kobe-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: BANDO CHEMICAL INDUSTRIES, LTD., Kobe-shi, Hyogo (JP)

(21) Appl. No.: 12/867,485

(22) PCT Filed: Feb. 10, 2009
(86) PCT No.: PCT/JP2009/000539

§ 371 Date: Aug. 12, 2010

(30) Foreign Application Priority Data
Feb. 13, 2008 (JP) 2008-032109

(51) Int. Cl. F16G 1/06

(52) U.S. Cl. 474/237

(57) ABSTRACT

A friction drive belt for transmitting power while being wound around a pulley such that a compression rubber layer provided on an inner periphery of a belt body is in contact with the pulley enables both of noise reduction during the run of the belt and greater durability. A plurality of pores 15 having an average size of 5-120 μm are formed in the compression rubber layer 12 such that the compression rubber layer 12 has an air content of 5-40%.

### TECHNICAL FIELD

The present invention relates to friction drive belts in each of which a compression rubber layer provided on the inner periphery of a belt body is wound around pulleys such that the compression rubber layer is in contact with the pulleys and which serve to transmit power.

The present invention belongs to technical fields of noise reduction and durability improvement.

### BACKGROUND ART

Conventionally, as a structure for transmitting a driving force of, e.g., an engine or a motor to the driven side, the following structure has been widely known. Specifically, pulleys are coupled to shafts on the driving side and the driven side, and a friction drive belt is wound around these pulleys. Such a friction drive belt requires not only high power transmission capability but also quietness during the run of the belt. In order to satisfy these requirements, the friction coefficient of the belt surface needs to be reduced to the extent that predetermined power transmission capability can be ensured.

For example, when the friction drive belt is a V-ribbed belt, the friction drive belt has the following configuration as described in PATENT DOCUMENT 1 and other documents. Specifically, short fibers which are oriented in a widthwise direction of the belt are mixed into a compression rubber layer being in contact with pulleys in order to reinforce the compression rubber layer, and the short fibers protrude beyond the belt surface to reduce the friction coefficient of the belt surface, thereby improving quietness and wear resistance.

PATENT DOCUMENT 1 describes above shows the following configuration. Specifically, a rubber composition into which powders made of a thermosetting resin are blended is used to enable a reduction in the friction coefficient of the belt surface even with the loss of the short fibers from the compression rubber layer and wear on the short fibers.

Furthermore, for example, PATENT DOCUMENT 2 describes the following configuration. Specifically, a blowing agent is blended into a rubber layer (e.g., a compression rubber layer of a V-ribbed belt) forming the friction drive surface of a friction drive belt so that the resultant rubber layer has an air content of 5-20%, and then the blowing agent is expanded.

PATENT DOCUMENT 1: Japanese Patent Publication No. 2006-266280

PATENT DOCUMENT 2: Japanese Patent Publication No. 2007-255635

### SUMMARY OF THE INVENTION

### Technical Problem

Incidentally, like PATENT DOCUMENT 1 described above, a friction drive belt including a compression rubber layer mixed with short fibers needs to be configured such that the amount of the mixed short fibers is increased in order to significantly reduce noise production. This may, however, cause many drawbacks, such as poor dispersion of the short fibers and slips caused due to an increase in stiffness of the belt itself.

By contrast, like PATENT DOCUMENT 2 described above, a blowing agent is blended into a compression rubber layer and then expanded, thereby reducing the friction coefficient of the rubber layer itself. This reduction eliminates the need for increasing the amount of the mixed short fibers, thereby eliminating the drawbacks mentioned above.

However, when a foam structure of the rubber layer is defined only by the air content of the rubber layer like PATENT DOCUMENT 2 described above, the sizes of air bubbles cannot be controlled. Thus, a large air bubble may form a discontinuity, leading to degradation of, e.g., bending fatigue resistance and wear resistance. This may decrease durability.

The present invention has been made in view of the foregoing point, and it is an object of the invention to provide a friction drive belt which is wound around pulleys such that a compression rubber layer provided on the inner periphery of the belt body is in contact with the pulleys and which achieves both of noise reduction during the run of the belt and greater durability.

### Solution to the Problem

In order to achieve the above object, in a friction drive belt according to the present invention, a plurality of pores having an average size of 5-120 μm are formed in a compression rubber layer being in contact with pulleys such that the compression rubber layer has an air content of 5-40%, thereby enabling both of noise reduction during the run of the belt and durability improvement.

Specifically, a first aspect of the invention is directed to a friction drive belt for transmitting power while being wound around a pulley such that a compression rubber layer provided on an inner periphery of a belt body is in contact with the pulley. A plurality of pores having an average size of 5-120 μm are formed in the compression rubber layer such that the compression rubber layer has an air content of 5-40%.

With this configuration, not only the air content affecting the friction coefficient, but also the average size of the pores affecting durability, such as wear resistance, can be within their respective appropriate ranges. This enables both of reduction in friction coefficient and durability improvement. Specifically, when, as illustrated in Table 1 described below, the air content is within the range of 5-40%, this can reduce the friction coefficient. This reduction can prevent slipping noises.

When the average size of the pores formed in the compression rubber layer is within the range of 5-120 μm, this can increase the effect of noise reduction during the run of the belt and reduce abrasion loss, resulting in durability improvement. However, when the average size of the pores is less than the above-described range, the effect of noise reduction is reduced. On the other hand, when the average size of the pores is greater than the above-described range, the wear resistance of the belt decreases, and the pores may cause cracks. The pores preferably have an average size of 10-100 μm, and more preferably have an average size of 20-80 μm. If any one of the pores has a size exceeding 150 μm even with the average size of the pores within the above-mentioned range, the pore having a size exceeding 150 μm may cause cracks. Therefore, no pore having a size exceeding 150 μm preferably exits.

Preferably, in a rubber processing step for the compression rubber layer, uncrosslinked rubber is impregnated with supercritical or subcritical fluid, and then a phase of the supercritical or subcritical fluid is changed to gas, thereby forming the pores with expansion of the fluid (a second aspect of the invention). This enables the formation of pores with expansion of supercritical or subcritical fluid. Therefore, the configuration described above eliminates the need for mixing hollow particles etc. into the compression rubber layer, thereby providing lower material cost than when the hollow particles are used. In particular, the supercritical or subcritical fluid is preferably supercritical or subcritical carbon dioxide, or supercritical or subcritical nitrogen (a third aspect of the invention). Such use of carbon dioxide or nitrogen can relatively easily achieve supercritical or subcritical conditions, and enables the kneading of rubber material without affecting the rubber material.

In contrast, pores may be formed using hollow particles without forming pores using supercritical fluid as described above. Specifically, the pores may be formed using hollow particles mixed into uncrosslinked rubber in a rubber processing step for the compression rubber layer and expanding by being heated (a fourth aspect of the invention).

With this configuration, if the dispersion of the hollow particles in the compression rubber layer is controlled, this enables control of the dispersion of the pores, and the use of the hollow particles enables the formation of many independent pores having substantially the same shape. This also facilitates control of the shapes of the pores etc. This allows the shape of the contact surface of the compression rubber layer with the pulley to be precisely controlled in accordance with required characteristics.

Furthermore, in the above configuration, the belt body is preferably a V-ribbed belt body (a fifth aspect of the invention). The fifth aspect of the invention is particularly useful for a V-ribbed belt generally used, e.g., to transmit power to engine accessories of an automobile because the fifth aspect of the invention can reduce noise during the run of the belt while increasing durability.

### ADVANTAGES OF THE INVENTION

In view of the above, according to the friction drive belt of the present invention, a plurality of pores having an average size of 5-120 μm are formed in the compression rubber layer such that the compression rubber layer has an air content of 5-40%. This enables both of noise reduction resulting from reduction in the friction coefficient of the belt and prevention of a decrease in durability due to the pores. In particular, while the use of supercritical or subcritical fluid can reduce material cost, the use of hollow particles enables control of, e.g., the dispersion of the pores and the shapes of the pores, thereby permitting precise control of the shape of the surface of the compression rubber layer.

### BRIEF DESCRIPTION OF THE DRAWINGS

FIG. 1 is a perspective view illustrating a schematic structure of an example of a friction drive belt according to an embodiment of the present invention, i.e., a V-ribbed belt.

FIG. 2 is a diagram illustrating a layout of pulleys in a belt running tester for a wear resistance test.

FIG. 3 is a diagram illustrating a layout of pulleys in a belt running tester for a noise measurement test.

### DESCRIPTION OF REFERENCE CHARACTERS

B V-Ribbed Belt (Friction Drive Belt)
10 V-Ribbed Belt Body
11 Adhesion Rubber Layer
12 Compression Rubber Layer
13 Rib
15 Pore
16 Cord
17 Back Face Canvas Layer
30, 40 Belt Running Tester
31, 41 Drive Pulley
32, 42 Driven Pulley
43, 44 Idler Pulley

### DESCRIPTION OF EMBODIMENTS

Embodiments of the present invention will be described hereinafter with reference to the drawings. The following preferred embodiments are merely examples in nature, and are not intended to limit the scope, applications, and use of the invention.

### First Embodiment

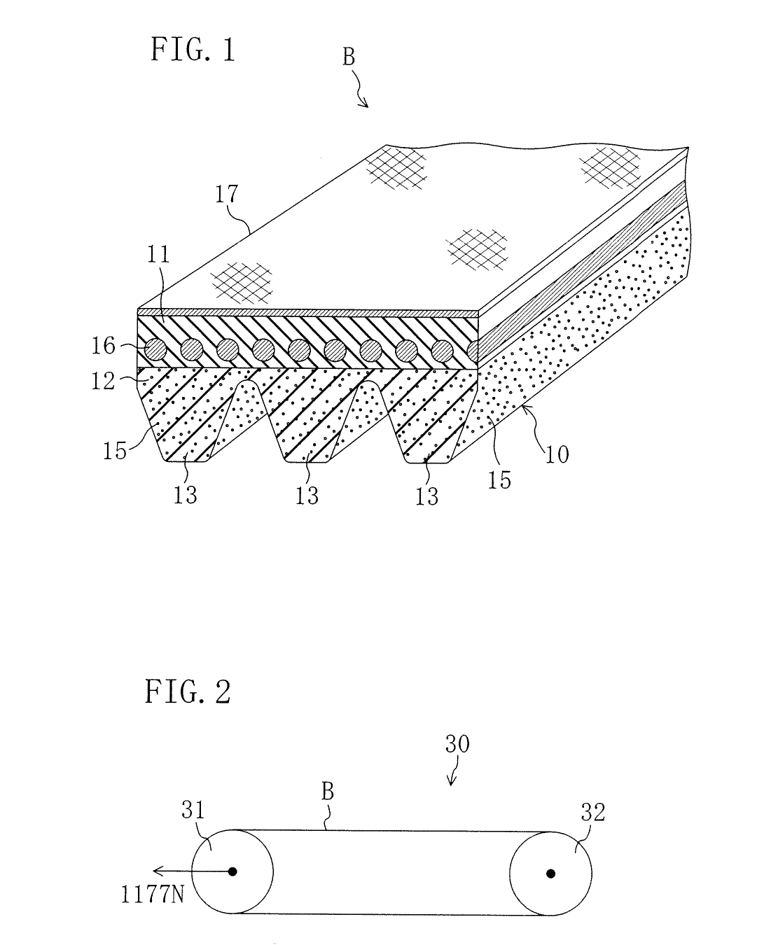

A V-ribbed belt B is illustrated in FIG. 1 as an example of a friction drive belt according to a first embodiment of the present invention. The V-ribbed belt B includes a V-ribbed belt body 10, and a back face canvas layer 17 laminated on the upper face (i.e., the back face or the outer periphery) of the V-ribbed belt body 10. The V-ribbed belt body 10 includes an adhesion rubber layer 11 which is generally rectangular when viewed in cross section, and a compression rubber layer 12 laminated on the lower face of the adhesion rubber layer 11, i.e., the lower face (i.e., the bottom face or the inner periphery) of the V-ribbed belt body 10.

The back face canvas layer 17 is obtained by subjecting a woven fabric of, e.g., cotton fibers, polyamide fibers, or polyester fibers to an adhesion treatment using rubber cement obtained by dissolving rubber in a solvent, and is adhered onto the back face of the V-ribbed belt body 10 (adhesion rubber layer 11). Thus, the back face canvas layer 17 plays a part in transmitting power when the belt is wound around flat pulleys such that the back face of the belt is in contact with the flat pulleys (e.g., back face idlers).

In contrast, the adhesion rubber layer 11 is made of a rubber composition of, e.g., ethylene-propylene-diene monomer rubber (EPDM) which is highly resistant to heat and weathering, chloroprene rubber (CR), or hydrogenated acrylonitrile-butadiene rubber (H-NBR). The adhesion rubber layer 11 has a cord 16 embedded therein. The cord 16 extends along the lengthwise direction of the belt, and is wound in a spiral form so as to be spaced at a predetermined pitch in the belt widthwise direction. The cord 16 is obtained by twisting a plurality of single yarns made of fibers, such as aramid fibers or polyester fibers. The compression rubber layer 12 is made of a rubber composition which contains EPDM as a base rubber and in which not only carbon black but also various rubber compounding ingredients are blended into EPDM. Examples of the rubber compounding ingredients include crosslinkers, antioxidants, processing aids, and hollow particles. The base elastomer is not limited to EPDM, but may be CR or H-NBR.

The compression rubber layer 12 has many pores 15 which are formed therein such that the compression rubber layer 12 has an air content of 5-40% and which have an average size of 5-120 μm. The pores 15 are formed by blending hollow particles into the compression rubber layer 12 and heating and expanding the hollow particles. The pores 15 preferably have an average size of 10-100 μm, and more preferably have an average size of 20-80 μm. When the average size of the pores 15 is less than 5 μm, the effect of reducing noise is poor. On the other hand, when the average size of the pores 15 is greater than 120 μm, the wear resistance of the belt B decreases, and the pores 15 may cause cracks. If any one of the pores 15 has a size exceeding 150 μm even with the average size of the pores 15 within the above-mentioned range, the pore 15 having a size exceeding 150 μm may cause cracks. Therefore, no pore having a size exceeding 150 μm preferably exits.

Examples of the hollow particles include Matsumoto Microsphere F-85 and Matsumoto Microsphere F-80VS both made by Matsumoto Yushi-Seiyaku Co., Ltd. When Matsumoto Microsphere F-85 is used as the hollow particles, the size of each of the hollow particles is, e.g., approximately 15-25 μm. When Matsumoto Microsphere F-80VS is used as the hollow particles, the size of each of the hollow particles is, e.g., approximately 5-8 μm. The pores 15 formed using Matsumoto Microsphere F-85 have an average size of approximately 8-55 μm, and the pores 15 formed using Matsumoto Microsphere F-80VS have an average size of approximately 5-10 μm.

In the V-ribbed belt B according to this embodiment, such short fibers as contained in a conventional V-ribbed belt are not blended into the compression rubber layer 12. However, like the conventional belt, short fibers may be blended into the compression rubber layer 12. Specifically, the blending of short fibers into the compression rubber layer 12 may cause cracks arising from bending of the belt B. Therefore, it is preferable that, like the V-ribbed belt B according to this embodiment, short fibers are not blended into the compression rubber layer 12. However, for example, when the hardness of rubber is to be changed, 10 or less parts by weight of short fibers may be blended into 100 parts by weight of base elastomer. For example, aramid fibers or polyester fibers are preferably used as the short fibers. The short fibers are preferably oriented in the belt widthwise direction.

The lower face of the compression rubber layer 12 is provided with a plurality of (in this embodiment, three) ribs 13, 13, . . . extending in the belt lengthwise direction. The ribs 13, 13, . . . are arranged at a predetermined pitch in the belt widthwise direction. Thus, when the V-ribbed belt B is wound around pulleys, the side surfaces of the ribs 13 of the compression rubber layer 12 abut against the side surfaces of the grooves of the pulleys.

Next, an example of a method for fabricating a V-ribbed belt configured as described above will be described.

In fabricating the V-ribbed belt B, an inner mold having a molding outer surface for forming the belt back face into a predetermined shape and a rubber sleeve having a molding inner surface for forming the inner face of the belt into a predetermined shape are used.

The outer periphery of the inner mold is first covered with back face canvas of a woven fabric to which an adhesive is applied, and an unvulcanized rubber sheet for forming a part of an adhesion rubber layer 11 located near the back face of the belt B is then wound around the back face canvas.

Subsequently, a cord 16 to which an adhesive is applied is helically wound around the unvulcanized rubber sheet, another unvulcanized rubber sheet for forming an inside part of the adhesion rubber layer 11 is then wound around the cord-wound unvulcanized rubber sheet, and still another unvulcanized rubber sheet for forming a compression rubber layer 12 is then further wound around the unvulcanized rubber sheet for forming the inside part. A composition obtained by mixing, e.g., a filler, such as carbon black, rubber compounding ingredients, such as plasticizers, and hollow particles into the raw rubber material in a rubber processing step is used as the unvulcanized rubber sheet for forming the compression rubber layer 12. When the unvulcanized rubber sheets are wound, both end parts of each of the unvulcanized rubber sheets in the winding direction face each other without being laid one on the other.

Thereafter, the rubber sleeve is fitted onto the molding article on the inner mold, and the rubber sleeve fitted onto the molding article is placed into a molding pan. Then, the inner mold is heated, e.g., by hot steam, and a high pressure is applied to the rubber sleeve to press the rubber sleeve radially inwardly. During this process, the raw rubber material fluidizes, a crosslinking reaction proceeds, and furthermore, adhesion reactions of the cord 16 and the back face canvas to the rubber also proceed. For example, pentane or hexane in the hollow particles in the compression rubber layer 12 is volatilized and expanded by the heating of the hollow particles for crosslinking. Thus, a cylindrical belt slab is molded.

Then, the belt slab is removed from the inner mold and separated at different locations of its length into several pieces, and the outer periphery of each separated piece is ground to form ribs 13. In this case, the hollow particles exposed at the contact surface of the ribs 13 with the pulleys are partially removed, and thus, recesses are formed in the contact surface.

Finally, the separated belt slab piece having ribs formed on the outer periphery is sliced into pieces of predetermined width, and each sliced piece is turned inside out to provide a V-ribbed belt B.

The method for fabricating a V-ribbed belt is not limited to the method described above. Layers may be laminated on an inner mold having the shape corresponding to ribs in a sequential order from a compression rubber layer 12, and the layers may be pressed between the inner mold and an outer mold while being heated.

With the above-described structure, the presence of the many pores 15 can reduce the friction coefficient, and can prevent the durability from decreasing due to the pores 15. Specifically, when the air content of the compression rubber layer 12 is within the range of 5-40%, this can reduce the friction coefficient of the contact surface of the compression rubber layer 12. Meanwhile, when the average size of the pores 15 is within the range of 5-120 μm, this can reduce wear of the belt arising from the pores 15 forming discontinuities as much as possible, and can prevent a reduction in durability.

As described above, the use of hollow particles can ensure the formation of many independent pores 15 in the compression rubber layer 12. Specifically, since the pores 15 are formed in the compression rubber layer 12 using hollow particles, the pores 15 in the compression rubber layer 12 are not continuous, i.e., separate from one another, and each have an approximately spherical shape. This enables precise control of the size and shape of each of the pores 15.

### Second Embodiment

Next, a V-ribbed belt according to a second embodiment of the present invention will be described hereinafter. The second embodiment is different from the first embodiment in a kneading method in order to form an unvulcanized rubber sheet for forming a compression rubber layer 12 of a belt B.

Specifically, supercritical or subcritical fluid is used in a rubber processing step in which filler-containing uncrosslinked rubber is prepared by kneading uncrosslinked raw rubber material and filler.

Here, the supercritical fluid denotes fluid under supercritical conditions. The supercritical conditions correspond to the conditions under which the fluid has a temperature of greater than or equal to the critical temperature (Tc) of the fluid and a pressure of greater than or equal to the critical pressure (Pc) of the fluid.

The subcritical fluid denotes fluid under subcritical conditions. The subcritical conditions correspond to the conditions under which only one of the temperature and pressure of the fluid reaches the critical one while the other one does not reach the critical one, or the conditions under which the temperature and pressure of the fluid do not reach the critical temperature and pressure, respectively, while at least one of the temperature and pressure of the fluid is sufficiently higher than normal and is approximately critical.

In other words, in this embodiment, under the subcritical conditions, the temperature (T) and pressure (P) of fluid satisfy any one of the following requirements:

0.5<T/Tc<1.0 and 0.5<P/Pc; and

0.5<T/Tc and 0.5<P/Pc<1.0.

Under the subcritical conditions which are preferable for the kneading of the rubber material, the temperature (T) and pressure (P) of fluid satisfy any one of the following requirements:

0.6<T/Tc<1.0 and 0.6<P/Pc; and

0.6<T/Tc and 0.6<P/Pc<1.0.

If the critical temperature Tc (Celsius) of fluid is negative, the temperature requirement should be satisfied. If the requirement for the supercritical conditions is not satisfied, and the pressure requirement represented by 0.5<P/Pc is satisfied, the fluid should be subcritical.

Examples of materials which can change into the supercritical or subcritical fluid include carbon dioxide, nitrogen, hydrogen, xenon, ethane, ammonia, methanol, and water. Among these materials, carbon dioxide and nitrogen are suitably used to knead the rubber material.

The critical temperature (Tc) of carbon dioxide is 31.1° C., and the critical pressure (Pc) thereof is 7.38 MPa. Thus, supercritical carbon dioxide has a temperature T of greater than or equal to 31.1° C. and a pressure P of greater than or equal to 7.38 MPa. In contrast, subcritical carbon dioxide satisfies any one of the following requirements:

15.55° C.<T<31.1° C. and 3.69 MPa<P; and

15.55° C.<T and 3.69 MPa<P<7.38 MPa.

The critical temperature (Tc) of nitrogen is −147.0° C., and the critical pressure (Pc) thereof is 3.40 MPa. Thus, supercritical nitrogen has a temperature T of −147.0° C. and a pressure P of 3.40 MPa. In contrast, subcritical nitrogen does not satisfy the requirement for the supercritical conditions, but satisfies the requirement represented by 1.70 MPa<P.

In the presence of supercritical or subcritical fluid, other liquids or gases may exist together with the supercritical or subcritical fluid without hindering the kneading of the rubber material.

In the presence of such supercritical or subcritical fluid, the rubber material is kneaded by using a kneader including a kneading unit, such as a rotor or a screw, placed in a hermetic rubber kneading chamber with excellent heat resistance and excellent pressure resistance. Such a kneader may be a continuous kneader which conducts the delivery of uncrosslinked rubber and filler and the discharge of filler-containing uncrosslinked rubber in a continuous manner. Alternatively, such a kneader may be a batch kneader which kneads a predetermined amount of uncrosslinked rubber and a predetermined amount of filler and from which the kneaded filler-containing uncrosslinked rubber is removed. Examples of the former include a twin screw extruder described in Japanese Patent Publication No. 2002-355880. Examples of the latter include a kneader and a Banbury mixer.

When, during mechanical agitation and kneading of uncrosslinked rubber and filler using the kneading unit in the kneader, supercritical or subcritical fluid exits together with the uncrosslinked rubber and the filler as described above, this allows the supercritical or subcritical fluid to dissolve in the uncrosslinked rubber and diffuse thereinto. In this case, the filler is diffused into the uncrosslinked rubber together with supercritical or subcritical fluid having high solubility and high diffusibility. This can improve the dispersibility of the filler in the uncrosslinked rubber.

Then, after the sufficient kneading of the uncrosslinked rubber and the filler, the internal pressure of the rubber kneading chamber is reduced, and supercritical or subcritical fluid in the kneaded ingredients is expanded, i.e., undergoes a phase change to gas. In this case, the internal pressure of the chamber should be instantaneously reduced in order to enable the formation of pores. In order to allow the size of such pores to be smaller than required, the internal pressure is controlled also in consideration of the subsequent expansion of the fluid arising from heating in a rubber crosslinking step. The rubber may be merely soaked in the supercritical or subcritical fluid without kneading the rubber in the presence of the supercritical or subcritical fluid as described above.

Since the supercritical or subcritical fluid, thus, forms a core of foam, this enables the formation of many pores 15 without using hollow particles for the compression rubber layer 12 of the belt B. In view of the above, the use of the above-described configuration provides lower material cost than the use of hollow particles, and can prevent the hollow particles from having an influence on the compression rubber layer.

Examples of the filler include carbon black and short fibers. A rubber compounding ingredient (e.g., an antioxidant, a crosslinker, or a crosslinking accelerator) other than such a filler may be kneaded together with the uncrosslinked rubber and the filler in the presence of supercritical or subcritical fluid.

### Third Embodiment

Next, a V-ribbed belt according to a third embodiment of the present invention will be described hereinafter. The third embodiment is different from the first and second embodiments in a method for forming many pores 15 in a compression rubber layer 12 of a belt B.

Specifically, when uncrosslinked rubber for the compression rubber layer 12 is prepared, various rubber compounding ingredients are added to EPDM serving as raw rubber material, and a chemical blowing agent is blended into the EPDM. Examples of the chemical blowing agent include Cellmic CAP 500 made by SANKYO KASEI Co., Ltd. For example, approximately 3 parts by weight of chemical blowing agent is preferably blended into 100 parts by weight of EPDM.

Then, uncrosslinked rubber is heated to crosslink rubber, thereby thermally decomposing the chemical blowing agent in the uncrosslinked rubber. Since this produces a nitrogen gas, a foamed rubber composition can be formed using the nitrogen gas produced in the rubber.

### Other Embodiments

In the embodiments described above, a friction drive belt is directed to a V-ribbed belt. However, the friction drive belt is not limited to a V-ribbed belt. As long as a rubber layer is in contact with pulleys, the friction drive belt may be any belt, such as a V-belt or a flat belt.

### EXAMPLES

Tests conducted on V-ribbed belts and the evaluation results of the tests will be described hereinafter.

(Belts for Test Evaluation)

V-ribbed belts of first through sixth examples and first through fifth comparative examples described below were fabricated. The compositions of these belts are also collectively illustrated in Table 1 described below.

### First Example

As a first example, a V-ribbed belt having a configuration similar to the belt configuration of the first embodiment was fabricated in which EPDM was used as a rubber material, i.e., a raw rubber material and in which a compression rubber layer was formed using a rubber composition obtained by blending 70 parts by weight of carbon black, 5 parts by weight of softner, 5 parts by weight of zinc oxide, 1 part by weight of processing aid, 2.5 parts by weight of antioxidant, 2 parts by weight of sulfur serving as a crosslinker, 4 parts by weight of accelerator, and 6 parts by weight of hollow organic particles B into 100 parts by weight of the EPDM.

### Second Example

As a second example, a V-ribbed belt was fabricated with the same configuration as the first example except that the amount of hollow particles B blended into a rubber composition used to form a compression rubber layer was 15 parts by weight.

### Third Example

As a third example, a V-ribbed belt was fabricated with the same configuration as the first example except that a compression rubber layer was formed using a rubber composition which is obtained by kneading the ingredients other than the hollow organic particles B in the presence of supercritical carbon dioxide (at a saturation pressure P of 20 MPa) and expanding carbon dioxide at a foaming temperature of 50° C. and a decompression speed of 7 MPa/sec.

### Fourth Example

As a fourth example, a V-ribbed belt was fabricated with the same configuration as the third example except that a compression rubber layer was formed using a rubber composition obtained by kneading the rubber material at a saturation pressure P of 6 MPa and expanding carbon dioxide at a foaming temperature of 70° C. and a decompression speed of 7 MPa/sec.

### Fifth Example

As a fifth example, a V-ribbed belt was fabricated with the same configuration as the third example except that a compression rubber layer was formed using a rubber composition obtained by kneading the rubber material at a saturation pressure P of 6 MPa and expanding carbon dioxide at a foaming temperature of 80° C. and a decompression speed of 7 MPa/sec.

### Sixth Example

As a sixth example, a V-ribbed belt was fabricated with the same configuration as the first example except that a compression rubber layer was formed using a rubber composition obtained by blending, in place of the hollow organic particles B, 3 parts by weight of chemical blowing agent.

### First Comparative Example

As a first comparative example, a V-ribbed belt was fabricated with the same configuration as the first example except that a compression rubber layer was formed using a rubber composition into which the hollow organic particles B are not blended.

### Second Comparative Example

As a second comparative example, a V-ribbed belt was fabricated with the same configuration as the first comparative example except that a compression rubber layer was formed using a rubber composition obtained by blending the same ingredients as in the first comparative example and 1 part by weight of hollow organic particles A into 100 parts by weight of EPDM.

### Third Comparative Example

As a third comparative example, a V-ribbed belt was fabricated with the same configuration as the first comparative example except that a compression rubber layer was formed using a rubber composition obtained by blending the same ingredients as in the first comparative example and 30 parts by weight of hollow organic particles B into 100 parts by weight of EPDM.

### Fourth Comparative Example

As a fourth comparative example, a V-ribbed belt was fabricated with the same configuration as the first comparative example except that a compression rubber layer was formed using a rubber composition obtained by kneading the ingredients in the presence of supercritical carbon dioxide (at a saturation pressure P of 15 MPa) and expanding carbon dioxide at a foaming temperature of 40° C. and a decompression speed of 7 MPa/sec.

### Fifth Comparative Example

As a fifth comparative example, a V-ribbed belt was fabricated with the same configuration as the fourth comparative example except that a compression rubber layer was formed using a rubber composition obtained by kneading the rubber material at a saturation pressure P of 5 MPa and expanding carbon dioxide at a foaming temperature of 90° C. and a decompression speed of 7 MPa/sec.

Here, Nordel IP4725P made by The Dow Chemical Company was used as the EPDM, and Seast 3 made by Tokai Carbon Co., Ltd. was used as the carbon black. Furthermore, Sunflex 2280 made by Japan Sun Oil Company, Ltd., Aenka #1 made by Sakai Chemical Industry Co., Ltd., bead STEARIC ACID CAMELLIA made by NOF CORPORATION, NOCRAC 224 made by OUCHI SHINKO CHEMICAL INDUSTRIAL CO., LTD., OIL SULFUR made by Tsurumi Chemical Industry Co., Ltd., and EP-150 made by OUCHI SHINKO CHEMICAL INDUSTRIAL CO., LTD. were used as the softener, the zinc oxide, the processing aid, the antioxidant, the sulfur, the accelerator, respectively. Moreover, Cellmic CAP 500 made by SANKYO KASEI Co., Ltd., Matsumoto Microsphere F-80VS made by Matsumoto Yushi-Seiyaku Co., Ltd., Matsumoto Microsphere F-85 made by Matsumoto Yushi-Seiyaku Co., Ltd. were used as the chemical blowing agent, the hollow organic particles A, and the hollow organic particles B, respectively.

(Test Evaluation Method)

<Wear Resistance Test>

FIG. 2 illustrates a layout of a belt running tester 30 for use in evaluation of a wear resistance test for V-ribbed belts. The belt running tester 30 includes a drive pulley 31 and a driven pulley 32 both forming ribbed pulleys each having a diameter of 60 mm.

The weights of the V-ribbed belts of the first through sixth examples and the first through fifth comparative examples were measured, and then each of the V-ribbed belts was wound around the pulleys 31 and 32 such that the ribs 13 were in contact with the pulleys 31 and 32. In this state, the drive pulley 31 was pulled sideways such that a dead weight of 1177 N was imposed on the drive pulley 31, and a rotational load of 7 W was imposed on the driven pulley 32. Then, a belt running test was conducted in which the drive pulley 31 was rotated at a rotational speed of 3500 rpm for 24 hours under room temperature.

The weight of each belt after the run of the belt run was measured, and the abrasion loss (%) thereof was calculated based on

Abrasion Loss (%)=(Initial Weight−Weight After Belt Run)/Initial Weight×100.

<Noise Measurement Test>

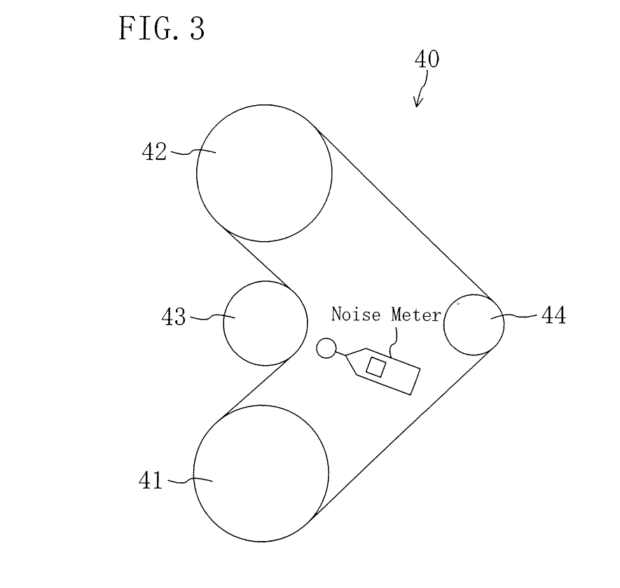

FIG. 3 illustrates a layout of a belt running tester 40 for measuring noises generated by V-ribbed belts. The belt running tester 40 includes a drive pulley 41 and a driven pulley 42 which are disposed one above the other and which form ribbed pulleys each having a diameter of 120 mm, an idler pulley 43 of 70 mm diameter disposed vertically midway between the drive pulley 41 and the driven pulley 42, and an idler pulley 44 of 55 mm diameter located vertically midway between the drive pulley 41 and the driven pulley 42 and lateral to the pulleys 41 and 42. Specifically, the driven pulley 42 is disposed above the drive pulley 41; the idler pulley 43 is disposed vertically midway between these pulleys 41 and 42 when viewed from the front of these pulleys 41 and 42; and an idler pulley 44 is disposed to the right of the idler pulley 43 (to the right of the page of FIG. 3) when viewed from the front. The idler pulleys 43 and 44 are placed to each have a total arc of contact of 90° with the belt.

Each of the V-ribbed belts of the first through sixth examples and the first through fifth comparative examples was wound around the four pulleys 41-44, and the idler pulleys 43 and 44 were set such that a load of 2.5 kW per rib was imposed on the driven pulley 42 and a set weight of 277 N per rib was imposed on the idler pulley 44. Then, a belt running test was conducted by rotating the drive pulley 41 at a rotational speed of 4900 rpm.

A microphone of a noise meter (Model Name: “NA-40” made by RION Co., Ltd) was disposed approximately 10 cm laterally away from the location where each belt is in contact with the idler pulley 43. Then, noises generated during the belt running test were measured.

Here, as noises during the run of the belts, slipping noises were determined which were caused by exposing the drive pulley 41 to water (200 cc/minute) after the run of the drive pulley 41 for the fixed distance.

(Test Evaluation Results)

The test results are illustrated in Table 1.

TABLE 1

| | First | Second | Third | Fourth | Fifth |
|---|---|---|---|---|---|
| | Comparative | Comparative | Comparative | Comparative | Comparative |
| | Example | Example | Example | Example | Example |
| EPDM | 100 | 100 | 100 | 100 | 100 |
| Carbon Black | 70 | 70 | 70 | 70 | 70 |
| Softener | 5 | 5 | 5 | 5 | 5 |
| Zinc Oxide | 5 | 5 | 5 | 5 | 5 |
| Processing Aid | 1 | 1 | 1 | 1 | 1 |
| Antioxidant | 2.5 | 2.5 | 2.5 | 2.5 | 2.5 |
| Sulfur | 2 | 2 | 2 | 2 | 2 |
| Accelerator | 4 | 4 | 4 | 4 | 4 |
| Chemical Blowing Agent | | | | | |
| Hollow Organic Particles A | | 1 | | | |
| Hollow Organic Particles B | | | 30 | | |
| Supercritical Foaming | — | — | — | 40 | 90 |
| Temperature (° C.) | | | | | |
| Saturation Pressure (MPa) | — | — | — | 15 | 5 |
| Average Pore Size (μm) | 0 | 7.3 | 57 | 2.9 | 127 |
| Air Content (%) | 0 | 3.8 | 44.7 | 5.8 | 27.8 |
| Abrasion Loss (%) | 1.1 | 1 | 3.1 | 1.1 | 3.5 |
| Belt Slipping Noise | Large | Medium | None | Large | None |

| | First | Second | Third | Fourth | Fifth | Sixth |
|---|---|---|---|---|---|---|
| | Example | Example | Example | Example | Example | Example |
| EPDM | 100 | 100 | 100 | 100 | 100 | 100 |
| Carbon Black | 70 | 70 | 70 | 70 | 70 | 70 |
| Softener | 5 | 5 | 5 | 5 | 5 | 5 |
| Zinc Oxide | 5 | 5 | 5 | 5 | 5 | 5 |
| Processing Aid | 1 | 1 | 1 | 1 | 1 | 1 |
| Antioxidant | 2.5 | 2.5 | 2.5 | 2.5 | 2.5 | 2.5 |
| Sulfur | 2 | 2 | 2 | 2 | 2 | 2 |
| Accelerator | 4 | 4 | 4 | 4 | 4 | 4 |
| Chemical Blowing Agent | | | | | | 3 |
| Hollow Organic Particles A | | | | | | |
| Hollow Organic Particles B | 6 | 15 | | | | |
| Supercritical Foaming | — | — | 50 | 70 | 80 | — |
| Temperature (° C.) | | | | | | |
| Saturation Pressure (MPa) | — | — | 20 | 6 | 6 | — |
| Average Pore Size (μm) | 61 | 100 | 5.1 | 60 | 99 | 75 |
| Air Content (%) | 13.2 | 31.5 | 38.9 | 20.5 | 24.1 | 5.1 |
| Abrasion Loss (%) | 1.6 | 2.8 | 1.8 | 2.1 | 2.7 | 1.9 |
| Belt Slipping Noise | None | None | Small | None | None | Small |

The test results show that examples each including a compression rubber layer 22 in which many pores 15 are formed such that the compression rubber layer 22 has an air content of greater than or equal to 5% (the first through sixth examples and the third and fifth comparative examples) allow belt slipping noises to be lower than an example without pores 15 (the first comparative example) and an example including a compression rubber layer 22 having an air content of less than 5% (the second comparative example). A possible reason for this is that the formation of many pores 15 can reduce the friction coefficient of the contact surface of the belt B.

In contrast, the test results show that the abrasion loss of the third comparative example having an air content of greater than 40% is greater than that of each of examples having an air content of less than or equal to 40% (the first through sixth examples and the second and fourth comparative examples). Such an excessively high air content reduces the strength of the contact surface of the belt B, thereby causing significant abrasion. In view of the above, the test results show that the air content is preferably less than or equal to 40% because such an air content causes insignificant abrasion. The ratio between the total cross-sectional areas of pores 15 and the cross-sectional area of rubber (a portion of the compression rubber layer 22 other than the pores 15) was determined, as the air content, based on the results of image processing of observed images described below.

In view of the above, the air content is preferably 5-40%. Specifically, the air content is preferably less than or equal to 40% like the first through sixth examples exhibiting particularly low abrasion loss, and the air content is preferably greater than or equal to 5% like the first through sixth examples which are less likely to cause noises.

Furthermore, the test results show the following: an example in which the average size of the pores 15 is large (the fifth comparative example) exhibits higher abrasion loss than examples in which the average size thereof is small (the first through sixth examples and the second through fourth comparative examples), and thus, has inferior durability. Since the suitable abrasion loss of the belt B is less than approximately 3%, the results in Table 1 described above show that the average size of the pores 15 is preferably within the range of 5-120 μm. Specifically, the average size of the pores 15 is more preferably 10-100 μm and still more preferably 20-80 μm because such an average size of the pores 15 provides low abrasion loss and increases the effect of reducing belt slipping noises. The average size of the pores 15 was determined in the following manner: the use of the digital microscope VHX-200 made by KEYENCE CORPORATION or the scanning electron microscope S-4800 made by Hitachi High-Technologies Corporation provides an observed image magnified by 450 times (for the digital microscope) or 100,000 times (for the scanning electron microscope), and then the average size of all the pores 15 in the observed image was determined using the image processing software WinROOF made by MITANI CORPORATION.

In view of the above, in order to reduce belt slipping noises, the air content is preferably greater than or equal to 5%. In view of the belt durability, the air content is preferably less than or equal to 40%, and the average size of the pores is preferably 5-120 μm. When the air content and the average size of the pores fall within such ranges, this enables both of noise reduction and belt durability improvement.

### INDUSTRIAL APPLICABILITY

As described above, the friction drive belt of the present invention reduces noises while increasing the belt durability, and therefore, is useful for a belt used for, e.g., automobiles and wound around pulleys to transmit power.

1. A friction drive belt for transmitting power while being wound around a pulley such that a compression rubber layer provided on an inner periphery of a belt body is in contact with the pulley,
wherein a plurality of pores having an average size of 5-120 μm are formed in the compression rubber layer such that the compression rubber layer has an air content of 5-40%.

2. The friction drive belt of claim 1, wherein
in a rubber processing step for the compression rubber layer, uncrosslinked rubber is impregnated with supercritical or subcritical fluid, and then a phase of the supercritical or subcritical fluid is changed to gas, thereby forming the pores with expansion of the fluid.

3. The friction drive belt of claim 2, wherein
the supercritical or subcritical fluid is supercritical or subcritical carbon dioxide, or supercritical or subcritical nitrogen.

4. The friction drive belt of claim 1, wherein
the pores are formed using hollow particles mixed into uncrosslinked rubber in a rubber processing step for the compression rubber layer and expanding by being heated.

5. The friction drive belt of claim 1, wherein
the belt body is a V-ribbed belt body.
